(19) United States
(12) Patent Application Publication
(10) Pub. No.: US 2024/0092051 A1
(43) Pub. Date: Mar. 21, 2024

(54) SEMI-CONSOLIDATED REINFORCED THERMOPLASTIC PIPE WITH PREPREG REINFORCED CORE LAYER

(71) Applicant: SAUDI ARABIAN OIL COMPANY, Dhahran (SA)

(72) Inventors: Abderrahim Fakiri, Dhahran (SA); Waleed Al Nasser, Ad Dammam (SA); Thibault Tarik Villette, Belfort (FR)

(73) Assignee: SAUDI ARABIAN OIL COMPANY, Dhahran (SA)

(21) Appl. No.: 17/932,413

(22) Filed: Sep. 15, 2022

(51) Int. Cl. B32B 1/08; B29C 63/00; B29C 63/34; B29C 70/22; B32B 5/02; B32B 5/08; B32B 5/12; B32B 7/028; B32B 37/14; B32B 37/20

(52) U.S. Cl. CPC B32B 1/08; B29C 63/0021; B29C 63/0069; B29C 63/34; B29C 70/22; B32B 5/024; B32B 5/08; B32B 5/12; B32B 7/028; B32B 37/144; B32B 37/206; B29L 2023/22

(57) ABSTRACT

A thermoplastic pipe and a method for producing a thermoplastic pipe are provided. The thermoplastic pipe includes a liner layer, a semi-consolidated core layer comprising a prepreg polymeric fabric layer, and a shrink wrap outer layer. The semi-consolidated core layer comprises a thermoplastic polymer matrix that is randomly distributed across the fabric. The method includes producing a hollow inner liner layer, winding a prepreg comprising a polymeric powder scattered on a fabric over the hollow inner liner layer to produce a core layer, covering the core layer in a heat shrinkable wrap, and heating to produce a semi-consolidated core layer. The semi-consolidated core layer comprises a thermoplastic polymer matrix that is randomly distributed across the fabric.

### BACKGROUND

In the oil and gas industry, the trend is to replace steel pipelines whenever possible with composite pipelines. Over the years, many composite piping technologies have been developed such as RTR (Reinforced Thermoset Resin), RTP (Reinforced Thermoplastic Pipe), and TCP (Thermoplastic Composite Pipe). The RTP and TCP technologies are spoolable and complement one another. RTP is made of a liner, a dry fiber reinforced core, and an outer layer. Due to the fact that the core layer is made of dry fiber, RTP attains a low to medium pressure rating, higher flexibility and smaller bending radius. On the other hand, TCP has a fully bonded structure with a core layer made of unidirectional (UD) tape in which all fibers are fully consolidated within a matrix. This allows TCP to have a high-pressure rating but less flexibility and a larger bending radius.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for producing a thermoplastic pipe comprising producing a hollow inner liner layer, winding a prepreg comprising a polymeric powder scattered on a fabric over the hollow inner liner layer to produce a core layer, covering the core layer in a heat shrinkable wrap, and heating one or more of the hollow inner liner layer, the core layer, and the heat shrinkable wrap at least one time to produce a semi-consolidated core layer, wherein the semi-consolidated core layer comprises a thermoplastic polymer matrix that is randomly distributed across the fabric.

Other embodiments disclosed herein also relate to a thermoplastic pipe comprising a liner layer, a semi-consolidated core layer comprising a prepreg polymeric fabric layer that is wound around the liner layer and heated, and a shrink wrap outer layer over the semi-consolidated core layer, wherein the prepreg polymeric fabric layer comprises a fiber, and wherein the semi-consolidated core layer further comprises a thermoplastic polymer matrix that is randomly distributed across the fabric.

Other aspects and advantages of the claimed subject matter will be apparent from the following description and the appended claims.

### BRIEF DESCRIPTION OF DRAWINGS

FIG. 1 is a depiction of the operation envelope of reinforced thermoplastic pipe (RTP) and thermoplastic composite pipe (TCP) and semi-consolidated reinforced thermoplastic pipe (SC-RTP) according to one or more embodiments disclosed herein.

FIG. 2A is an illustration of a prepreg polymeric fabric according to one or more embodiments disclosed herein.

FIG. 2B is an illustration of a prepreg polymeric fabric according to one or more embodiments disclosed herein.

FIG. 3 is an illustration of a process diagram according to one or more embodiments disclosed herein.

FIG. 4 is a plot of stress-strain behavior of PVDF matrix according to one or more embodiments herein.

### DETAILED DESCRIPTION

For the purpose of this description, a single reference number will be assigned to a line as well as a stream carried in that line. Same reference numbers refer to similar components. The person skilled in the art will readily understand that while the design is illustrated referring to one or more specific combinations of features and measures many of those features and measures are functionally independent from other features and measures. Such features and measures may be equally or similarly applied independently in other embodiments or combinations.

Reinforced thermoplastic pipe (RTP), due the lack of a consolidated intermediate layer, is generally capable of withstanding pressures of up to approximately 1500 psig (about 10342 kPa). On the other end of the scale, thermoplastic composite pipe (TCP), with a fully consolidated intermediate layer, is capable of withstanding pressure of up to approximately 10,000 psig (about 68929 kPa). However, TCP is expensive to produce and has a larger bend radius making the use of TCP in all field applications undesirable.

Accordingly, one or more embodiments disclosed herein are directed toward a reinforced thermoplastic pipe (RTP) with a semi-consolidated (SC) core layer (SC-RTP) which may exhibit an improved pressure resistance over RTP without the large bend radius of TCP (thermoplastic consolidated pipe). The SC-RTP may include at least three layers. In one or more embodiments, the innermost of the at least three layers may include a hollow inner liner, a core layer may be wrapped around the outside of the inner liner, and a heat shrinkable wrap layer may then be placed on the outside of the core layer. Such an arrangement of layers may allow for the SC-RTP to be able to withstand pressure of up to approximately 2900 psig (about 19995 kPa). Each of these layers will now be discussed in more detail.

The hollow inner liner may be formed from a thermoplastic through any means known to those skilled in the art. These may include, but are not limited to, extrusion or pultrusion. In one or more embodiments, the inner liner may be extruded to the target liner thickness and diameter. Extrusion may produce any thickness needed for the inner liner. In some embodiments, the molten thermoplastic may be pulled by a puller after exiting a cylindrical die prior to being cooled and solidified. The range of the thickness (outside diameter minus inside diameter) of the inner liner may have an upper limit of any of about 25 mm, about 20 mm, about 15 mm, about 10 mm, about 9 mm, or about 8 mm, and have a lower limit of any of about 0.5 mm, about 1 mm, about 2 mm, about 5 mm, about 6 mm, or about 6.5 mm. Any upper limit may be combined with any lower limit. In one or more embodiments, the outer diameter of the inner liner is in the range from about 1 inch to about 24 inches. In one or more embodiments, the outer diameter range may have an upper limit of any of 24 inches, 18 inches, or 12 inches and a lower limit of any of 1 inch, 2 inches, 4 inches, or 6 inches. The thickness of the internal liner may depend upon the desired pressure rating, the composition of the liner, the reinforcement layer properties, and other factors known to one skilled in the art.

Internal liners according to embodiments herein may be formed from natural or synthetic rubbers or other man-made polymers as known in the art. The polymers used to form the internal liners, or an innermost layer thereof, may be selected based on the properties of the material to be conveyed or handled in the spoolable composite pipes and pressure vessels according to embodiments herein. The inner layer may include a polymeric material such as a thermoplastic. In some embodiments, internal liners useful in embodiments herein may be formed from polyethylenes such as ultra-high molecular weight polyethylene (UHMWPE), high density polyethylene (HDPE), or medium density polyethylene (MDPE), or from other materials such as polyethylene of raised temperature (PE-RT), polyvinylidene fluoride (PVDF), polyamide (PA), polyphenylene sulfide (PPS), or polyketone (POK).

The hollow inner liner may be spooled on a reel after being extruded for storage before subsequent steps in the pipe manufacturing process. In other embodiments, the core layer and cover layer may be disposed on the inner liner directly, without an intermediate spooling step.

The core layer may be a prepreg fabric. The prepreg may include a polymeric powder scattered, coated, or disposed on one or both sides of a fabric. In one or more embodiments, the polymeric powder may include, but is not limited to one or more of polyvinylidene fluoride, polyethylene, polypropylene, polyamide, polyethylene terephthalate, or a combination thereof. In some embodiments, the polymeric powder may be of a polymer similar to the hollow inner liner material. In one or more embodiments, the hollow inner liner may have a higher melting point as compared to the polymeric powder. In some embodiments, the fabric may be a woven, a cross-ply, or a nonwoven fabric, or other fabrics apparent to those of ordinary skill in the art. In other embodiments, the fabric may be fibers that may include, but are not limited to, carbon fiber, glass fiber, aramid fiber, or basalt fiber.

Because the polymeric powder is scattered over the fabrics, it may wet the fabric when melted. The polymer powder material may be selected to be compatible with the liner material to have a good bonding and strong interface with it. The polymer powder may have an average particle diameter in the range from about 1 micron to 500 microns. The average particle diameter may have an upper limit of any of about 500 microns, about 400 microns, or about 300 microns and a lower limit of any of about 1 micron, about 10 microns, about 50 microns, about 100 microns, or about 200 microns, where any upper limit may be combined with any lower limit. The polymer powder material may have a melting point not exceeding the melting point of the liner and shrink wrap outer layer. This lower melting point may allow the polymer to melt and flow without damaging the integrity of the liner and shrink wrap outer layer. The melting point of the polymer powder may have a melting point that is at least 5° C. below that of the shrink wrap layer or the inner liner. The polymer powder material may have a melting point that is at least 5° C.-50° C. below that of the shrink wrap layer and the inner liner in order to promote bonding upon melting and subsequent cooling without negatively impacting the other layers during manufacture. The polymer powder may be selected to have a melting point that is greater than that of the end use temperature to prevent melting during operation.

In one or more embodiments, the fiber may be present in a volume fraction of the core layer in the range from about 20 vol % to about 80 vol %, for example with a lower limit of any of 20 vol %, 30 vol %, or 40 vol % to an upper limit of any of 60 vol %, 70 vol %, or 80 vol %, where any lower limit may be used in combination with any upper limit.

The prepreg fabric layer may be tightly wound around the inner liner using any method apparent to one of ordinary skill in the art. The prepreg fabric layer may be wound in one or more layers. In one or more embodiments, the core layer may have a two-layer wrapping. The winding angle may be in the range from about 1 to about 89 degrees, for example with a lower limit of any of about 1 degree, about 10 degrees, about 20 degrees, about 40 degrees, about 45 degrees, or about 50 degrees to an upper limit of any of about 60 degrees, about 65 degrees, about 70 degrees, about 80 degrees, or about 89 degrees where any lower limit may be used in combination with any upper limit. The winding angle may be measured clockwise or counter-clockwise from the pipe axis. The layers of prepreg fabric may be wrapped at the same or different winding angle. In some embodiments, the layers may be wrapped counter to each other so that the opposing forces of the final semi-consolidated fabric sufficiently support the inner liner and provide the desired reinforcement. The prepreg fabric layer may be wound around the inner liner to a thickness in the range of 4 mm to 25 mm for example with a lower limit of any of about 4 mm, about 5 mm, about 7 mm, or about 10 mm, and an upper limit of any of about 25 mm, about 22 mm, or about 20 mm, where any lower limit may be used in combination with any upper limit.

In one or more embodiments, after the core layer is wrapped around the hollow inner liner layer a heat shrinkable wrap may be tightly wound or extruded over the core layer, such as using a winding or wrapping processes. The material for the heat shrinkable wrap may have a good heat resistance to withstand heat when the polymer powder in the core layer is melting. The shrink wrap outer layer material and polymer powder material may be selected to so that they are compatible with one another to facilitate bonding between the core layer and the heat shrinkable wrap. The melting point of the heat shrinkable wrap may be greater than that of the polymer powder in some embodiments to allow for consolidation of the core layer without the shrink wrap outer layer melting.

In one or more embodiments, after wrapping the heat shrinkable film, the pipe structure may pass through a heating station (inline or offline) to consolidate the core layer. The heating station can be set at a temperature that is at least sufficient to melt the polymer powder in the core layer while the top wrap shrinks to push the molten polymer into the fabric. Sufficient heat must be applied to melt the polymer powder in the core layer without damaging the shrink wrap and the liner. In one or more embodiments, IR or convection heaters may be used for these purposes. The pipe structure may be heated at least one time. The level of consolidation in the core layer can be tailored by altering the fiber volume fractions, the heat intensity, the heating station length and size, line speed and shrink wrap material type and thickness depending on the final pressure requirement of the pipe. The final degree of consolidation may range from about 0.01% to about 99.99% for example with a lower limit of any of 0.01%, 10%, 20%, 30%, or 40% to an upper limit of any of 60%, 70%, 80%, 90%, or 99.99% where any lower limit may be used in combination with any upper limit. In some embodiments, the end product is a spoolable composite pipe with at least a liner, semi-consolidated core layer and a shrink wrap outer layer. If more consolidation is needed, post heating may take place. In other embodiments, the heating process to consolidate the core layer may occur during the shrink-wrapping process. The final semi-consolidated core layer comprises a thermoplastic polymer matrix that is randomly distributed across the fabric.

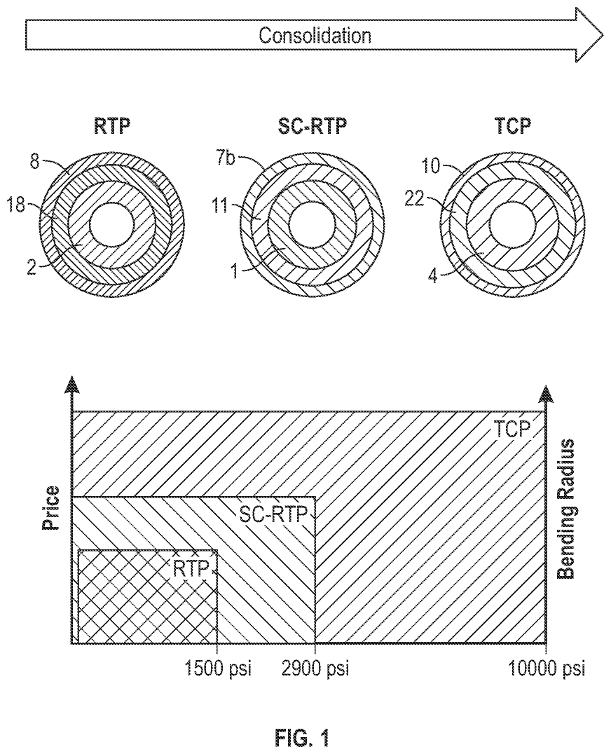

Referring now to the figures, FIG. 1 is a depiction of the operation envelope of RTP and TCP composite pipes. RTP, having a jacket layer 8 extruded over the core layer, a dry fiber reinforced core 18 and an inner liner 2, has a pressure rating of less than 1500 psig (about 10342 kPa) and a small bending radius. TCP, having an outer layer 10 extruded over the core layer, a core layer comprising a fully bonded structure 22, and an inner liner 4, has a pressure rating of up to 10,000 psig (about 68947 kPa) and a large bending radius. SC-RTP, having the previously described shrink wrap outer layer 7, semi-consolidated core 11, and inner liner 1 according to embodiments herein have been found to have a pressure rating of up to 2900 psig (about 19995 kPa) and a bending radius between RTP and TCP. In one or more embodiments SC-RTP may have a reduced bending radius with respect to TCP, while allowing for an increased pressure resistance over RTP.

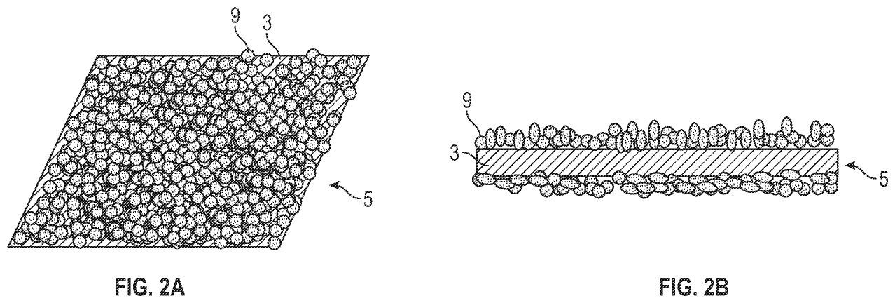

FIG. 2A is an illustration of a prepreg polymeric fabric according to one or more embodiments disclosed herein, specifically in a top view. The prepreg fabric 5 comprises fibers 3 coated with a polymer powder 9.

FIB. 2B is an illustration of a prepreg polymeric fabric according to one or more embodiments disclosed herein, specifically in a profile view. The prepreg fabric 5 comprises fibers 3 with a polymer powder 9 coating both sides.

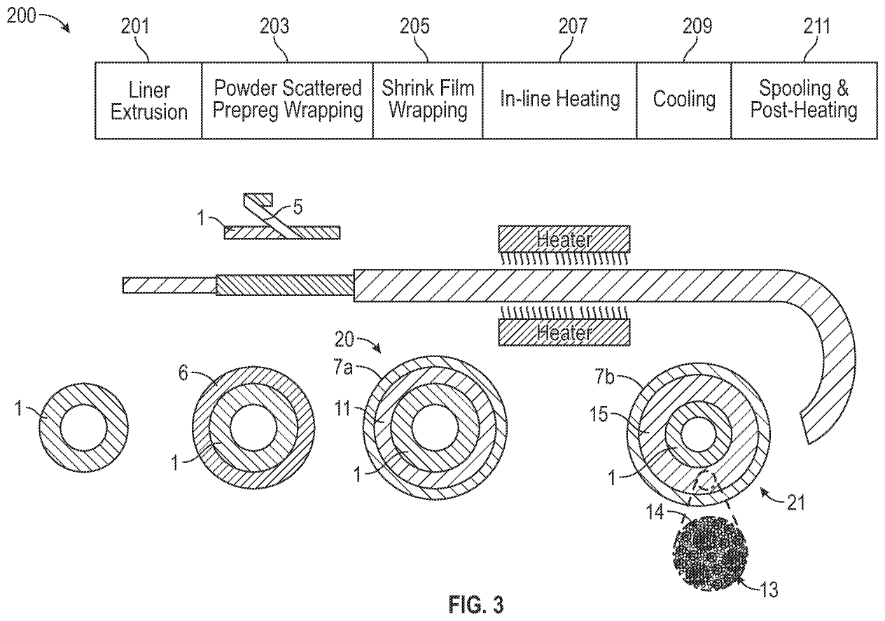

FIG. 3 illustrates a method 200 for the production of an SC-RTP according to one or more embodiments disclosed herein. Inner liner 1 may be produced via any method apparent to one of ordinary skilled in the art, such as extrusion. In one or more embodiments, the inner liner 1 may be produced by an extrusion process 201. A prepreg fabric 5 may be wrapped 203 around the inner liner 1 to produce an unconsolidated core 6 comprising a prepreg fabric 5. Unheated shrink film 7a may then be wrapped 205 around the unconsolidated core 6 before being heated 207 to produce a semi-consolidated core 15. The system 20 during heating 207 includes an inner liner 1, a core 11 comprising a prepreg fabric 5, and a shrink film wrapping 7a. In some embodiments, the heating 207 causes the shrink film 7a to shrink, melts the polymer, and as the wrap shrinks it pushes the molten polymer into the prepreg fabric 5. The piping can then be cooled 209, before being post-heated if desired and spooled 211.

The final SC-RTP system 21 comprises a core 15 comprising a fabric including some polymer-infused fibers 14 and some dry fibers 13. The core 15 surrounds a hollow inner liner 1 and a shrink wrap 7b that has been previously heated.

### EXAMPLES

A numerical modeling study was conducted where the three technologies were compared using PVDF (polyvinylidene fluoride) matrix (used for high temperature) and glass fibers as the constituents with the assumption that PVDF matrix is randomly distributed along the glass fibers. Three structures were developed by altering the volume space not occupied by glass fiber (void space) from 0% (all matrix TCP), 25% void (almost half void and matrix SC-RTP) and 47.7% (all void, RTP) as shown in Table 1.

TABLE 1
Simulation performance of the three structures.

| | TCP | SC-RTP | RTP |
|---|---|---|---|
| Matrix content (vol.) | 47.7 | 22.7 | 0 |
| Fiber content (vol.) | 52.3 | 52.3 | 52.3 |
| Void content (vol.) | 0 | 25.0 | 47.7 |

A representative volume element comprising a polymer matrix and glass fibers was constructed by two glass fiber plies oriented at +/−55° angle with respect to the pipe axis. The volume element was subjected to strain uniaxial loading in the hoop direction.

Following the design of the representative volume elements, a mesh was applied to the model and the system was subjected to a strain-driven uniaxial loading in the hoop direction to simulate the local response of the pipe under internal pressure. The loading imposed consisted of 3% strain in the hoop direction of the pipe. The representative volume element was left free in the longitudinal direction.

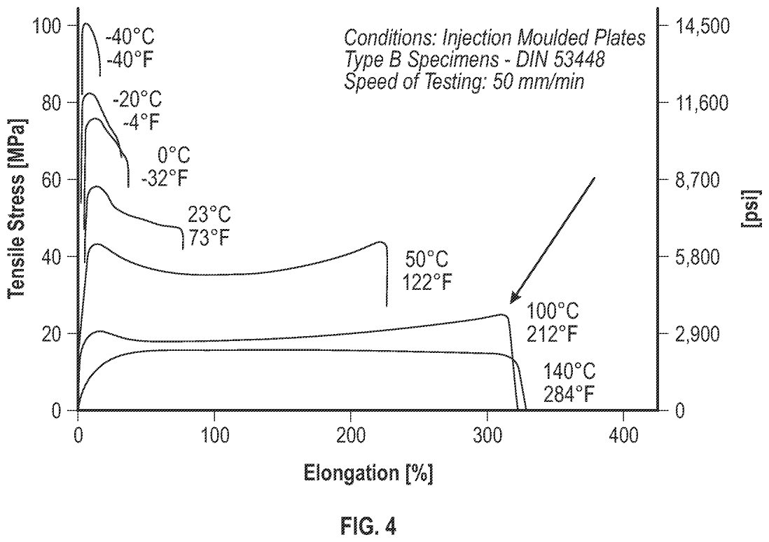

The material properties utilized in the finite element analysis to model the polymer matrix were extracted from a datasheet published by the material supplier. The polymer matrix material used in the analysis was a PVDF material, grade Solef® from the company SOLVAY). The selected temperature is 100° C. in order to simulate conditions close to real service conditions experienced in the O&G transportation. The stress-strain response of the polymer matrix is presented in FIG. 4. An elasto-plastic material model was used for the polymer matrix with a Young's modulus of 800 MPa, a maximum strength of 20 MPa, and an ultimate strain equal to 300%. An elastic material model was used for the glass fiber using generic data from the literature, with a Young's modulus of 70,000 MPa and a strength of 1,450 Mpa.

After the analysis was run, the post-processing consisted of analyzing and comparing the maximum effective strain and effective stress in the polymer matrix and at the composite scale. Finally, the stiffness of the resulting composite was estimated in the hoop direction, for each variant of the composite. The simulation results are shown in Table 2. The maximum matrix strain is a good indicator of how much strain is carried by the matrix before reaching its failure strain, 300% ultimate matrix strain (UMS) for this SOLEF® PVDF (polyvinylidene fluoride) at 100° C. For TCP, the matrix reached 47% of the UMS while for the SC-RTP structure the matrix reached 69% of the UMS which indicates the structure can carry the prescribed load without deforming significantly more while saving 50% of the matrix material as compared to TCP.

TABLE 2
Simulation performance results of the three structures

| | | 50% | 0% |
|---|---|---|---|
| | Fully | consolidation | consolidation |
| | consolidated | random matrix | structure (no |
| | structure, TCP | placement | matrix), RTP |
| Maximum matrix | 140% (47% of | 207% (69% of | N/A |
| strain (%) | strain failure) | strain failure) | |

Unless defined otherwise, all technical and scientific terms used have the same meaning as commonly understood by one of ordinary skill in the art to which these systems, apparatuses, methods, processes, and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” is used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A method for producing a thermoplastic pipe comprising:
producing a hollow inner liner layer;
winding a prepreg comprising a polymeric powder scattered on a fabric over the hollow inner liner layer to produce a core layer;
covering the core layer in a heat shrinkable wrap; and
heating one or more of the hollow inner liner layer, the core layer, and the heat shrinkable wrap at least one time to produce a semi-consolidated core layer,
wherein the semi-consolidated core layer comprises a thermoplastic polymer matrix that is randomly distributed across the fabric.

2. The method of claim 1, wherein the heating comprises heating the core layer to a temperature greater than the melting point of the polymeric powder and less than the melting point of the heat shrinkable wrap.

3. The method of claim 1, wherein the final degree of consolidation of the semi-consolidated core layer is between about 0.01% and about 99.99%.

4. The method of claim 1, further comprising post-heating one or more of the hollow inner liner layer, the core layer, and the heat shrinkable wrap.

5. The method of claim 1, wherein the polymeric powder comprises at least one polymer selected from the group consisting of: polyvinylidene fluoride, polyethylene, polypropylene, polyamide, polyethylene terephthalate, and a combination thereof.

6. The method of claim 1, wherein the hollow inner liner layer comprises a thermoplastic.

7. The method of claim 1, wherein the fabric comprises at least one material selected from the group consisting of: carbon fiber, glass fiber, aramid fiber, and basalt fiber.

8. The method of claim 1, wherein the prepreg comprises a fiber volume percent of 20% to 80%.

9. The method of claim 1, wherein the winding is performed at an angle measured from a pipe axis that is in range from 1 to 89 degrees in a clockwise or a counterclockwise direction.

10. The method of claim 1, wherein the fabric is selected from the group consisting of: woven fabric, cross-ply fabric, and nonwoven fabric.

11. The method of claim 1, wherein the producing the hollow inner liner layer comprises: extruding the hollow inner liner layer.

12. The method of claim 11, wherein extruding comprises passing a molten thermoplastic through a cylindrical die and subsequently pulling the molten thermoplastic.

13. A thermoplastic pipe comprising:
a liner layer;
a semi-consolidated core layer comprising a prepreg polymeric fabric layer that is wound around the liner layer and heated; and
a shrink wrap outer layer over the semi-consolidated core layer,
wherein the prepreg polymeric fabric layer comprises a fabric, and
wherein the semi-consolidated core layer further comprises a thermoplastic polymer matrix that is randomly distributed across the fabric.

14. The thermoplastic pipe of claim 13, wherein the prepreg polymeric fabric layer comprises a polymeric powder.

15. The thermoplastic pipe of claim 14, wherein the polymeric powder comprises at least one polymer selected from the group consisting of: polyvinylidene fluoride, polyethylene, polypropylene, polyamide, polyethylene terephthalate, and a combination thereof.

16. The thermoplastic pipe of claim 13, wherein the liner layer has a thickness from 0.5 mm to 25 mm.

17. The thermoplastic pipe of claim 13, wherein the liner layer has an outer diameter from 1 inch to 24 inches.

18. The thermoplastic pipe of claim 13, wherein the liner layer comprises a thermoplastic.

19. The thermoplastic pipe of claim 13, wherein the prepreg polymeric fabric layer comprises at least one material selected from the group consisting of: carbon fiber, glass fiber, aramid fiber, and basalt fiber.

20. The thermoplastic pipe of claim 13, wherein the prepreg polymeric fabric layer comprises a fiber volume percent of 20% to 80%.

21. The thermoplastic pipe of claim 13, wherein the prepreg polymeric fabric layer is wound around the liner layer at an angle from 1 to 89 degrees in a clockwise or a counter-clockwise direction measured from a pipe axis.

22. The thermoplastic pipe of claim 13, wherein the fabric is selected from the group consisting of: woven fabric, cross-ply fabric, and nonwoven fabric.
